(19) United States
(12) Patent Application Publication
(10) Pub. No.: US 2020/0104222 A1
(43) Pub. Date: Apr. 2, 2020

(54) SYSTEMS AND METHODS FOR MANAGING SERVER CLUSTER ENVIRONMENTS AND PROVIDING FAILURE RECOVERY THEREIN

(71) Applicant: HEWLETT PACKARD ENTERPRISE DEVELOPMENT LP, Houston, TX (US)

(72) Inventors: Balaji Ramamoorthi, Bangalore (IN); Siva Subramaniam Manickam, Bangalore (IN); Vinnarasu Ganesan, Bangalore (IN); Thavamaniraja Sakthivei, Bangalore (IN)

(21) Appl. No.: 16/146,162

(22) Filed: Sep. 28, 2018

(51) Int. Cl. G06F 11/20; H04L 12/24; H04L 29/08; G06F 9/50

(52) U.S. Cl. CPC G06F 11/2028; G06F 9/5027; H04L 67/1002; H04L 41/084

(57) ABSTRACT

Systems and methods are provided herein for server cluster environment management and failure recovery therein. Clusters of a cluster server environment are monitored by a resource manager. The resource manager maintains a standby server pool of servers from the server cluster environment. A cluster monitor monitors the clusters of servers and automatically detects server and cluster failures. An optimal recovery server from among the standby server pool is identified based on the configuration information of the failing server or the failing cluster. The identified optimal recovery server is added to the failing cluster or the cluster with the failing server, and configured based on the stored configuring information of the failed server or the failed cluster.

### BACKGROUND

Server cluster environments are logical or physical collections of servers that are logically or physically grouped into clusters. The servers forming each of the clusters are communicatively coupled with one another and are configured to function as a single system rather than as multiple independent systems. A cluster of servers can therefore provide the appearance of a single integrated system. Grouping servers into clusters allows the apparent single system formed by the cluster of servers to be highly available, balance workloads among the servers, perform parallel processing by the servers, enable simplified management of the servers, and facilitate scalability thereof. The clusters are configured and managed so as to maximize the availability of the functionality and resources provided by the servers and clusters.

### BRIEF DESCRIPTION OF THE DRAWINGS

Certain examples are described in the following detailed description and in reference to the drawings, in which:

FIG. 1 is a diagram illustrating an exemplary embodiment of a computing environment for deploying a management system for managing a server cluster environment.

FIG. 2 is a diagram illustrating an exemplary embodiment of a server of a computing environment.

FIG. 3 is a diagram illustrating an exemplary embodiment of a management system of the computing environment of FIG. 1.

FIG. 4 is a diagram illustrating an exemplary embodiment of a part of a computing environment of a management system managing clusters of servers.

FIG. 5 is a sequence diagram illustrating an exemplary embodiment of a cluster environment management and failure recovery process.

### DETAILED DESCRIPTION OF SPECIFIC EXAMPLES

Cluster server environment are made up of clusters of servers. These servers often form part of complex distributed computing environments, in which the servers and numerous other systems (e.g., shared storage devices, client devices, and the like) are interconnected over a number of different networks and links.

Servers are able to provide, serve or make available, to client systems, their hardware and software resources and functionality. For instance, servers can provide client systems (and thereby their client users) with access to the servers' memory and compute resources. This allows clients to execute (or have executed on their behalf) functions that would otherwise not be feasible. Servers can also be configured to execute one or more virtual machines, which are emulations of independent computing systems. These virtual machines can be of different types and configurations, for instance, as enabled by the hypervisors or virtual machine managers running on the servers. In addition, each of the virtual machines can run their own respective operating systems and applications.

The servers that make up a cluster are logically or physically grouped and configured to communicate with one another. When servers are clustered, they act or appear as a single cohesive system. There are various reasons for clustering servers, including the ability to enable load balancing, parallel processing, centralized management, scalability, and high availability. High availability of a cluster refers to the cluster's adherence to certain availability standards. For example, high availability clusters are often restricted to use only up to a certain amount of its servers, make available a certain amount of its servers to function as potential recovery servers, and/or provide recovery of failed servers within a certain amount of time.

Accordingly, under traditional techniques, if a server in a cluster fails, the virtual machines running on the failed server are moved to another server in the cluster while the failed server is attended to (e.g., restarted, fixed, etc.). While the failed server is attended to, number of total servers in the cluster is reduced, as is the number of potential recovery servers by virtue of one recovery server now being used by the virtual machines previously running on the failed server. This change in total available clusters and total potential recovery serves can cause the high availability characteristic of the cluster to be impacted. One way to address this shortcoming is by increasing the number of total servers in a cluster and/or reducing the number used or active clusters, so that server failures (even multiple server failures) would not impact the clusters adherence to high availability standards.

There is a need therefore for clusters to minimize the risk of exceeding their utilization thresholds when server failures occur without merely adding, to the cluster, recovery or replacement servers, which would be wasted resources that would sit unused. To this end, the embodiments described herein provide for management of a server cluster environment and recovery of server and cluster failures in a way that would not require the addition of unutilized resources to the cluster environment. In some embodiments described herein, a management system is provided for managing a plurality of servers. The management system can maintain a standby server pool, which is a logical collection of candidate recovery servers from across the clusters managed by the management system. The candidate recovery servers can be used when a server or cluster failure occurs. For example, if a server failure occurs, a candidate recovery server from the pool can be used to replace the failed server; if a cluster failure occurs (e.g., the cluster exceeds its utilization threshold), the candidate recovery server can be added to the cluster to reduce its total utilization. Because the standby server pool is made up from servers of many clusters, each clusters can thereby increase its number of potential recovery servers and therefore lower its utilization threshold without itself needing to add servers. Moreover, when a recovery server is added to a cluster due to a failure, the management system can configure the recovery server as needed, thereby enabling the servers in the standby server pool to be mapped to a range of diverse clusters, including clusters with different hypervisors.

Accordingly, in some embodiments, management of a server cluster environment by a management system is provided. A resource manager identifies clusters to be monitored, each of the clusters comprising one or more servers and forming a server cluster environment including a plurality of servers. A resource manager maintains a standby server pool, the standby server pool comprising one or more servers selected from among the plurality of servers. A configuration module stores configuration information of the clusters and the plurality of servers. The cluster monitor monitors the clusters and/or the plurality of servers. The cluster monitor automatically detects a failing cluster or failing server among the clusters or the plurality of servers. The resource manager identifies an optimal recovery server from among the one or more servers in the standby server pool and adds the optimal recovery server to the failing cluster or the cluster of the failing server. The optimal recovery server is configured based on one or more of the configuration information of the failing server or its corresponding cluster. The optimal replacement server is determined based on the configuration information of the failing cluster or failing server.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

### Distributed Computing Environment

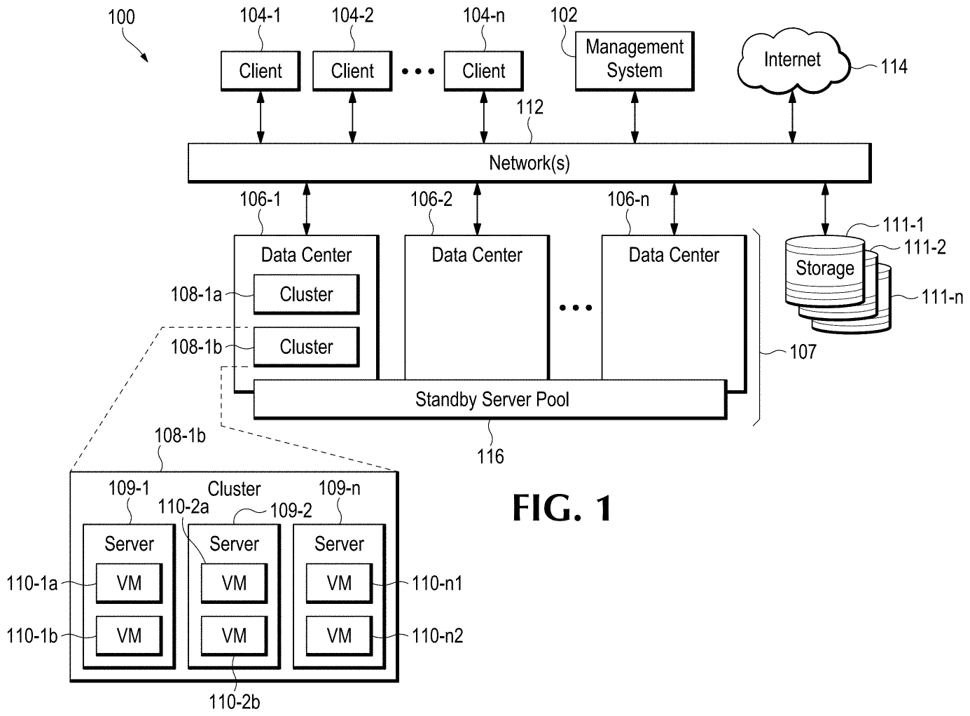

Turning to the figures, FIG. 1 is a system diagram illustrating an exemplary embodiment of a computing environment 100 for deploying computing systems such as a system for managing computing resources such as servers and clusters of a sever cluster environment. As shown in FIG. 1, the computing environment 100 includes the management system 102, clients 104-1, 104-2, . . . , and 104-n (collectively “clients” and/or “104”); data centers 106-1, 106-2, . . . , and 106-n (collectively “data centers” and/or “106”); and storage devices 111-1, 111-2, . . . , and 111-n (collectively “storage devices” and/or “111”).

Moreover, and as further detailed below, each of the data centers 106 can include one or more clusters (interchangeably referred to herein as “server clusters”), such as clusters 108-1a and 108-1b of the data center 106-1. Each of the clusters can be made up of one or more servers, such as servers 109-1, 109-2, . . . , and 109-n (collectively “servers” and/or “109”) of the cluster 108-1b, which are illustrated for exemplary purposes.. Each of the servers 109 can execute or include one or more virtual machines (VMs), such as VMs 110-1a and 110-1b of server 109, VMs 110-2a and 110-2b of server 109-2, and VMs 110-n1 and 110-n2 of server 109-n (collectively “VMs” and/or “110”). In some embodiments, the data centers 106 including the systems thereof are referred to and/or form a server cluster environment 107. The data centers, clusters, servers and VMs of FIG. 1 are shown for exemplary purposes and, it should be understood that the number of data centers, clusters, servers and VMs that form or are included in the computing environment 100 and/or managed by the management system 102 can vary as known to those of skill in the art.

The management system 102, clients 104, data centers 106, clusters 108, servers 109, VMs 110, and/or storage devices 111 can be connected with each other via one or more networks 112. It should be understood that the networks 112 can include physical, virtual and/or logical networks through which systems of the computing environment 100 can communicate. For instance, the networks 112 can include a local area network (LAN), a virtual private network (VPN), and/or a storage area network (SAN). As also illustrated in FIG. 1, the networks 112 can be coupled to one or more external networks 114, such as the Internet. The systems of the computing environment 100 can perform management, data, heartbeat, storage and other communications through the networks 112 and/or the Internet (and/or other external networks) 114. As known to those of skill in the art, various types of physical and virtual networks, and wired and wireless links or connections between the systems of the computing environment 100 can be implemented. In some embodiments, although not illustrated in FIG. 1, the servers 109 can include or provide virtual switches that enable communications therebetween.

Data centers (e.g., data centers 106) are physical or virtual infrastructures that house or include computing systems and components, such as computing servers (e.g., servers 109) and networking devices that can be used by companies or enterprises for storing, processing and serving data to clients (e.g., clients 104). The servers 109 and other resources can be physically or logically grouped into clusters (e.g., clusters 108), for instance, to function as a single system and to provide optimal or improved system availability, load balancing, parallel processing, scalability and the like.

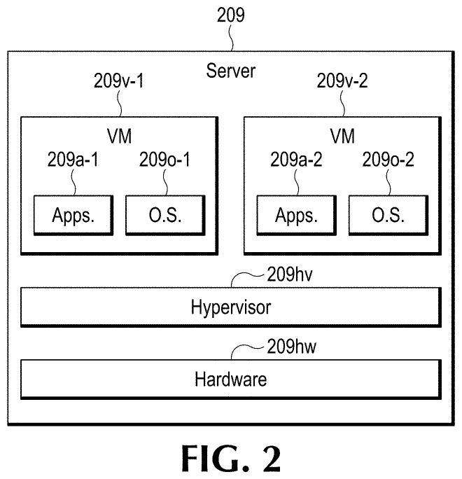

As known to those of skill in the art, the servers of the data centers 106, such as the servers 109, are host computing systems that provide resources or functionality (e.g., hardware, software) for other devices or software. The servers 109 can be any type of server such as computing servers, application servers, web servers, database servers and others known to those of skill in the art, and, as shown in FIG. 2, can include various types of hardware and software.

FIG. 2 is a system diagram illustrating a server 209 according to an exemplary embodiment. In some embodiments, a server is referred to interchangeably as a node or host. The server 209 includes hardware components 209hw, such a processors (e.g., central processing units (CPUs)), storage or memory devices, and communication or networking means such as network adapters. The terms storage or memory devices are used interchangeably herein to refer to volatile (e.g., random access memory (RAM)) and non-volatile (e.g., read-only memory (ROM)) memory. It should be understood that the number and types of devices making up the hardware components 209hw can vary as known to those of skill in the art.

In some embodiments, the storage or memory of the servers can include storage devices that are housed physically within the servers, or remotely in connected storage devices. For example, as shown in FIG. 1, the computing environment 100 includes storage devices 111 which are made up of hard disk drives and the like that can provide non-volatile storage. The storage devices 111 are connected to other systems in the computing environment 100, including the servers 109, via the networks 112. In some embodiments, the storage devices and servers (e.g., servers 109) are connected via a SAN, which allows the servers to write and read data to the storage devices as if the storage space was provided within the servers.

Returning to FIG. 2, the server 209 also includes a hypervisor 209hv (e.g., virtual machine monitor), which is hardware, software and/or firmware that creates, runs and manages multiple VMs on a server by, among other things, enabling the sharing of the server's resources, including its memory and processing devices. As shown in FIG. 2, the server 209 includes VMs 209v-1 and 209v-2, which can be system or process VMs. The VMs 209v-1 and 209v-2 share the resources of the server 209 to emulate independent computing systems. It should be understood that although only two VMs are illustrated in FIG. 2, the server 209 can include any number of VMs. The VMs 209v-1 and 209v-2 execute or run corresponding applications and operating systems 209a-1 and 209o-1, and 209a-2 and 209o-2, respectively. It should be understood that the applications and operating systems executed by the VMs 209v-1 and 209v-2 can be of different types from one another. For instance, the VM 209v-1 can execute a Windows operating system while the VM 209v-2 can execute a Linux operating system. In some embodiments, a server can include multiple and different hypervisors, which can be of different types such as KVM, VMWare® and Hyper-V. Likewise, servers in a cluster, or clusters in a data center, can be configured with different types of hypervisors relative to one another. The hardware and software configurations of servers and clusters can be stored for later access (e.g., in the event of failures), as described in further detail below.

As mentioned, the servers 109 are computing systems that make resources and functionality available to other systems and devices, such as clients 104. The clients 104 can be any of a variety of devices such as a desktop computer, laptop, workstation, mobile device, and/or server. The clients include one or more hardware components such as processors, storage devices (e.g., volatile and non-volatile memory), input/output devices (e.g., monitor, computer, mouse), network adapters, and others known to those of skill in the art. Using this hardware, the clients 104 can communicate with one or more servers (e.g., servers 109) in the data centers 106. In some embodiments, the clients 104 can access VMs (e.g., 110) on the servers, and use the data, applications and OSs of the VMs. The clients 104 can be operated by different types of users, including general users and administrators. The clients 104, when operated by different types of users, can be configured to access different OSs, applications, VMs, servers, clusters and/or data centers, and to perform different types of operations thereon.

In some embodiments, the clients 104 are configured to have reliable access to the servers of the clusters 106, including the VMs and data thereon. To this end, the clusters 106 are in some instances defined as “highly available clusters,” meaning that they are configured to adhere to certain standards, such as availability and utilization thresholds. The management system 102 is therefore provided, as shown in FIG. 1, to manage the clusters 106 and the servers thereon. Moreover, the management system 102 is configured to detect server failures in the clusters 106 and address failures as deemed optimal. For example, in some embodiments in which a server failure is detected, the management system 102 can replace the failed server with a server from a standby server pool 116 maintained by the management system 102. In this way, the management system 102 can ensure that the high availability standards of the highly available clusters 106 are met.

### Management System

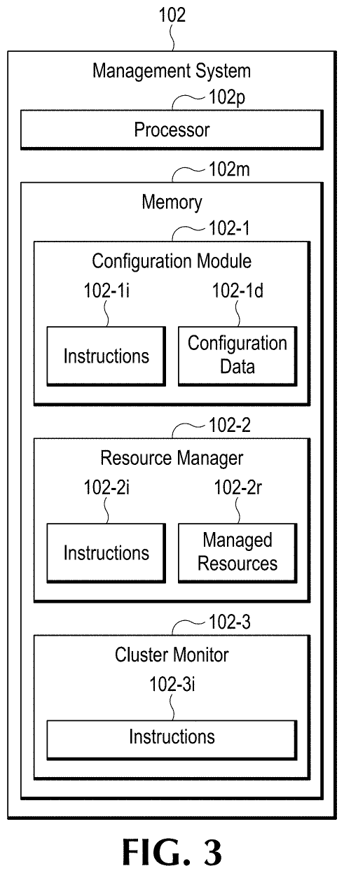

FIG. 3 is a system diagram of an exemplary embodiment of the management system 102. The management system 102 is a computing system that includes various types of hardware as known to those of skill in the art, including a processor 102p, a memory 102m. It should be understood that the processor 102p can refer to one or more processors, and the memory 102m can refer to one or many memory or storage devices including volatile and non-volatile memory types. Although not illustrated, the management system 102 includes one or more buses that enable communications among the components of the system 102, and one or more network adapters that enable communications with components, devices, or systems external to or not forming part of the system 102.

The management system 102 also includes a configuration module 102-1, a resource manager 102-2, and a cluster monitor 102-3. It should be understood that the configuration module 102-1, resource manager 102-2, and cluster monitor 102-3 can be implemented as software stored in the memory 102m, as illustrated in FIG. 3, or can be implemented in hardware in the form of a microcontrollers, system on chip (SoC) or the like.

Nonetheless, in some embodiments as shown in FIG. 3, the configuration module, resource manager and cluster monitor include instructions 102-1i (configuration module instructions), 102-2i (resource manager instructions), and 102-3i (cluster monitor instructions) that are stored in memory. When the instructions 102-1i, 102-2i, and 102-3i are executed by the processor 102p, the management system 102 operates as a configuration module, resource manager and/or cluster monitor, respectively. The operation of the management system 102 as the configuration module 102-1, resource manager 102-2, and cluster monitor 102-3 is described in further detail below.

The resource manager 102-2 includes or stores managed resource data 102-2r, which is data relating to the resources (e.g., clusters, servers) managed by and/or associated with the management system 102. This data can include identification information, status information, associations, and the like. In some embodiments, the resource manager 102-2 can communicate with servers and/or clusters to obtain the resource data, and/or can obtain that information from other components (e.g., cluster monitor). In some embodiments, the information obtained by the resource manager 102-2 can include configuration data, which is described in further detail below. It should be understood that the management system 102 can manage systems (and store information) on a per-server, per-cluster, and/or per-data center basis. In connection with each managed resource, the management system 102 can store various types of information as known to those of skill in the art, as shown in exemplary Table 1 below:

TABLE 1

| | | | | | | | |
|---|---|---|---|---|---|---|---|
| | | | | | | | STANDBY |
| | | | DATA | | | | SERVER |
| SERVER | | CLUSTER | CENTER | | | | POOL |
| ID | URL | ID | ID | . . . | STATE 1 | STATE 2 | FLAG |

| | | | | | | |
|---|---|---|---|---|---|---|
| SRV001 | http://srvrs/SRV001 | clst1A | Dtcr1000 | Up | Busy | False |
| SRV110 | http://srvrs/SRV110 | clst1B | Dtcr1003 | Down | N/A | False |
| SRV230 | http://srvrs/SRV230 | clst2D | Dtcr2010 | Up | Idle | True |
| SRV420 | http://srvrs/SRV420 | clst1A | Dtcr1000 | Up | Idle | True |
| SRV001 | http://srvrs/SRV001 | clst1A | Dtcr1000 | Up | Busy | False |

In some embodiments, the resources managed by the management system are determined or defined by an administrator. For instance, an administrator operating one of the clients 104 can communicate with the management system 102 and determine the clusters that the management system 102 is to manage, and whether any should be added or removed. Of course, the managed resources can be determined in other ways including through the use of machine learning techniques known to those of skill in the art.

The information obtained and tracked about each of the resources can be obtained by the management system 102 from different systems and over different networks, as described in further detail below. In some embodiments, the State 1 field shown in Table 1 indicates whether the server is up or down (e.g., functioning properly/as expected or not; online or offline), and the State 2 field indicates whether the server, if online, is idle (e.g., not performing any tasks) or busy (e.g., performing tasks). The Standby Server Pool Flag indicates whether the server is part of the standby server pool (e.g., FIG. 1, standby server pool 116). Based on the information gathered and tracked by the management system 102 (e.g., as shown in Table 1 above) about the managed resources, the management system can, among other things, identify failures such as servers or clusters that are faulty or problematic. Examples of server and cluster failures are described in further detail below.

Still with reference to FIG. 3, the configuration module includes or stores configuration data 102-1d, which is data indicating the manner in which the hardware and software of servers and clusters that are managed by the management system 102 are set up. For instance, the configuration information can include information indicating the shared storage devices with which the servers or clusters are associated; networking profiles and/or details indicating the connections to the shared storage and other devices; hypervisor, operating system and applications that are executed or executable; and corresponding license information. As described in further detail below, the configuration data of each server and/or cluster can be used during a recovery action executed by the management system 102. That is, the management system 102 can replace a failed server such that the replacement server can be configured to match the failed server, to the extent feasible, using the configuration data 102-1d. The replacement servers are selected by the management system 102 from the standby server pool 116. Resource management and system recovery will now described in further detail.

### Server Cluster Management and Failure Recovery

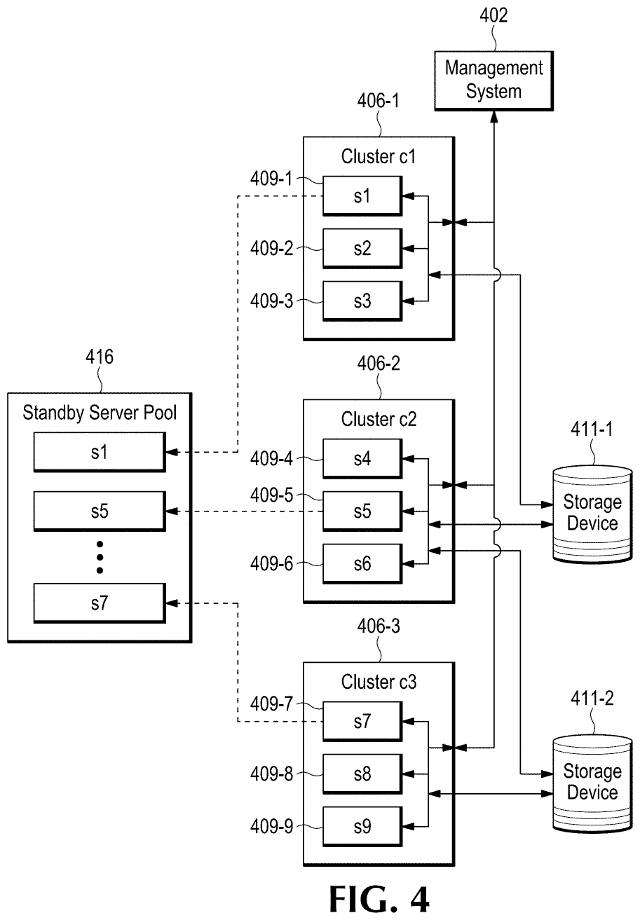

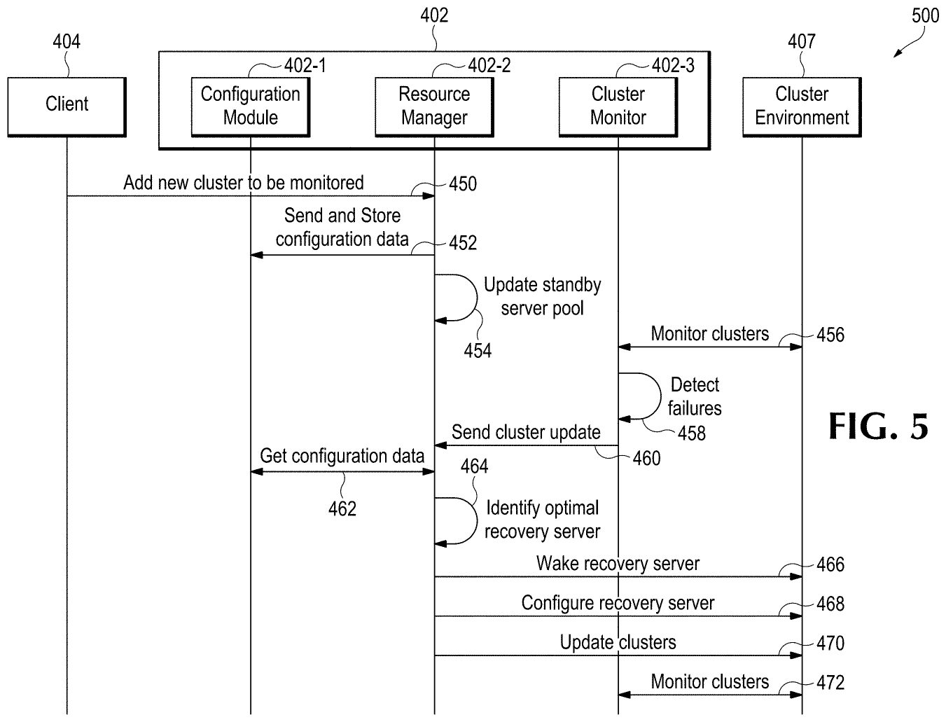

FIG. 4 is a system diagram illustrating an exemplary embodiment of a management system and cluster environment. As shown, a management system 402 manages and/or is associated with server clusters c1 (406-1), c2 (406-2) and c3 (406-3) (collectively “clusters 406”). It should be understood that the clusters 406 can be part of the same or different data centers. Moreover, the clusters 406 managed by the management system 402 can be referred to as a cluster environment or server cluster environment. Managing the clusters 406 includes managing the servers of those clusters. Such management includes identifying when failures occur in the clusters 406. When failures in the clusters 406 are detected, the management system 402 provides failure recovery by, for example, replacing or adding servers to clusters, so as to remedy the identified failure such that the clusters can be deemed “highly available.” Management and failure recovery of the clusters 106 is described in further detail below with reference to FIGS. 5 and 6.

As illustrated in FIG. 4, each of the clusters 406 includes or is made up of multiple servers. It should be understood that the management system 402 can manage or be associated with any number of clusters and servers different than the exemplary embodiment illustrated in FIG. 4. Cluster c1 includes servers s1 (409-1), s2 (409-2) and s3 (409-3); cluster c2 includes servers s4 (409-4), s5 (409-5), and s6 (409-6); and cluster c3 includes servers s7 (409-7), s8 (409-8), and s9 (409-9). These servers are in some instances referred to herein collectively as “servers 409.” Each of the servers 409 can include or execute a hypervisor that runs multiple virtual machines with corresponding operating systems and applications. In some instances, each of the clusters 406 is configured with servers that run the same type of hypervisor, as show in Table 2 below, which lists hypervisors of the clusters 406, and thus their corresponding servers, according to one exemplary embodiment:

TABLE 2

| SYSTEM | HYPERVISOR TYPE |
|---|---|
| Cluster c1 | KVM |
| Server s1 | KVM |
| Server s2 | KVM |
| Server s3 | KVM |
| Cluster c2 | Hyper-V |
| Server 4 | Hyper-V |
| Server 5 | Hyper-V |
| Server 6 | Hyper-V |
| Cluster 3 | VMware |
| Server 7 | VMware |
| Server 8 | VMware |
| Server 9 | VMware |

It should be understood that, in other embodiments, each of the servers 409 in the clusters 406 can run different types of hypervisors, as shown in Table 3 below, which lists hypervisors of the servers 409 according to one exemplary embodiment:

TABLE 3

| SYSTEM | HYPERVISOR TYPE |
|---|---|
| Server s1 | KVM |
| Server s2 | Hyper-V |
| Server s3 | KVM |
| Server s4 | VM-Ware |
| Server s5 | Hyper-V |
| Server s6 | KVM |
| Server s7 | KVM |
| Server s8 | VMware |
| Server s9 | VMware |

The clusters 406 and their corresponding servers are configured such that they are communicatively coupled to storage devices 411-1 and/or 411-2, where data can be stored. For instance, cluster 406-1 and its servers are communicatively coupled to storage device 411-1; cluster 406-2 and its servers are communicatively coupled to storage device 411-1 and 411-2; and cluster 406-3 and its servers are communicatively coupled to storage device 411-2. As described above, the clusters 406 and servers 409 can be communicatively coupled to the storage devices 411 via corresponding SANs. The connections of the clusters and servers to corresponding storage devices are stored and tracked by the configuration module of the management system 402.

Still with reference to FIG. 4, a standby server pool 416 is made up of multiple servers, such as servers s1, s5 and s7 from clusters 406-1, 406-2 and 406-3, respectively. It should be understood that the illustrated standby server pool 416 does not represent additional or different servers. Rather, the standby server pool 416 represents a group of servers mapped from one or more of the clusters 406. This logical mapping is represented in FIG. 4 by the dashed arrows from the clusters 406 to the standby server pool 416. In some embodiments, the servers in the standby server pool 416 can be referred to as candidate servers or candidate recovery servers. Moreover, in some embodiments, the logical mapping of the servers in the standby server pool 416 can be based on a standby server pool flag stored or maintained in association with each of the servers 409. In some embodiments, the servers in the standby server pool 416 are put in a sleep power mode, such that they consume minimal power while inactive. It should be understood that the standby server pool 416 can include any number of servers of different configurations (e.g., hypervisors, networks, storage devices) and from any number of clusters. The servers in the standby server pool 416 can be used to perform failure recovery by the management system 402, as follows.

FIG. 5 is a sequence diagram 500 illustrating an exemplary embodiment of a cluster management and failure recovery process. This process is illustrated with reference to the management system 402 described above in connection with FIG. 4. The management system 402 includes a configuration module 402-1, a resource manager 402-2 and a cluster monitor 402-3.

Prior to step 450, the cluster environment 407 is made up of multiple clusters, such as clusters c1, c2 and c3 described above in connection with FIG. 4. The cluster environment also includes a standby server pool 416, which is at that time instance made up of servers from the clusters in the cluster environment (e.g., c1, c2 and c3) that are identified as being eligible candidate recovery servers.

At step 450, a client system 404 adds a cluster cn to be monitored by the management system 402 by, for example, transmitting corresponding cluster information to the resource manager 402-2. The cluster information can include identifying and/or configuration data about the cluster cn and/or its servers. The cluster cn is therefore added to the cluster environment 407. As described herein, adding the cluster cn to the cluster environment refers to logically associating the cluster with the management system 402, to be managed thereby. In some embodiments, this can include storing cluster and/or server information such as that shown in Table 1 above in the managed resource data 402-2r of the resource manager 402-2. In light of the addition of the cluster cn, the cluster environment 407 at that time instance includes clusters c1, c2, c3, . . . , and cn.

In turn, at step 452, the resource manager 402-2 causes the configuration data of the new cluster cn and its servers to be stored by the configuration module 402-1 among its configuration data 402-1d. The configuration data of the new cluster cn and its servers can be obtained by the resource manager 402-2 from the client 404 and/or from the cluster cn and its servers.

Based on the configuration information of the new cluster cn and its servers, the resource manager identifies servers eligible to be added to the standby server pool 416 from among the other clusters (e.g., clusters 406-1, 406-2, 406-3). In some embodiments, the identified servers eligible for the standby server pool 416 are servers (other than those in the new cluster cn) that match or substantially mirror the configuration of the new cluster cn and its servers. Moreover, in some embodiments, servers eligible for the standby server pool are identified based on various conditions including: (i) whether their compute resource utilization (e.g., central processing unit (CPU), memory, disk utilization) is within a predefined range; (ii) the number of active VMs thereon, such that servers with no active VMs are deemed more optimal than servers having some active VMs; (iii) whether the servers are powered off for more than a defined threshold number of days; (iv) whether their connectivity to networks and/or systems matches or resembles the connectivity of the servers of the new cluster cn; and (v) other matching configurations (e.g., type of hypervisor executed)

At step 454, the resource manager 402-2 updates the standby nodes pool 416 with one or more of the servers identified as eligible, based on particular criteria selected and weighted by the resource manager 402-2. In this way, the standby server pool 416 is updated at step 454 such that its candidate recovery servers are configured to be able to replace or add to the servers of the new cluster cn. As a result, the management system 402 will be able to perform a recovery action in the event that the cluster cn or its servers fail. In some embodiments, updating the standby nodes pool in step 454 includes logically mapping one or more of the servers identified as eligible to the standby server pool 416.

Although updating the standby server pool 416 is shown in step 454 as being caused by the addition of the cluster cn to the cluster environment 407, it should be understood that updating the standby server pool 416 and/or identifying eligible servers for the standby server pool 416 can be performed at any time, including at periodic intervals and/or as triggered by predefined thresholds.

In turn, at step 456, the clusters of the cluster environment 407 are monitored by the cluster monitor 402-3 of the management system 402. It should be understood that cluster monitoring, although shown as a single step (step 456) in FIG. 5, refers to continuous and/or periodic times during the illustrated process. The monitoring of step 456 can include multiple back and forth communications such as requests and responses between the cluster monitor 402-3 and the clusters in the cluster environment 407 and/or the servers therein. At least one of the communications of step 456 includes a transmission of the status of the servers in the cluster environment 407. Such a transmission can be or include a heartbeat or the like, which is a periodic signal sent by each of the servers of the cluster environment 407 indicating the status of the servers. In some embodiments, the monitoring of step 456 includes transmitting resource utilization data from the servers and/or clusters in the cluster environment 407 to the cluster monitor 402-3. As known to those of skill in the art, this information enables a receiving system to identify whether a server has failed.

In turn, at step 458, the cluster monitor 402-3 detects a failure. The failure can be detected based on analyses of the information about the clusters and servers gathered during the monitoring of step 456 (or any other monitoring step not illustrated in FIG. 5), or by receiving an explicit failure or error notification from a cluster or server. In some embodiments, the failures identified at step 458 can be server failures or cluster failures.

For instance, a server failure can refer to an instance in which a server transmits a message to the cluster monitor 402-3 indicating that an error has occurred. A server failure can also refer to an instance in which a server does not transmit a heartbeat or status signal during an expected time, fails to acknowledge receipt of a message within a given amount of time, and/or fails to perform a requested task within a given amount of time. In other words, a server failure refers to a situation in which a server among the cluster environment 407 does not function as expected or allowed.

On the other hand, the failures identified at step 458 can be cluster failures. Cluster failures refer to an instance in which a cluster in the cluster environment 407 functions in unexpected or unpermitted ways. For example, a cluster failure can occur when cluster utilization exceeds an allowed threshold. Cluster utilization refers to the percentage of the cluster (e.g., measured or calculated based on the number of servers in the cluster) that is used at a given amount of time. When clusters are intended to be “high availability clusters,” the threshold utilization of those clusters is lowered, to ensure that there are more unused resources available for recovery in the event of failures. For example, if a cluster includes ten servers, a cluster utilization threshold of 80% indicates that no more than eight of the ten servers can be active and used at the same time, leaving two of the ten servers as potential backups for recovery. As explained herein, a standby server pool therefore allows a cluster to have servers of other clusters to be mapped thereto. Accordingly, a cluster with ten servers can use all of its servers and still comply with its utilization thresholds by having servers of other clusters that are in the standby server pool to be mapped or added thereto. Cluster failures can be identified by the cluster monitor 402-3 (in some cases working together with the resource manager 402-2) by analyzing the managed resource data (e.g., 402-2r) of the clusters to identify which and/or what percentage of servers in the clusters are active or busy.

At step 460, the cluster monitor 402-3 transmits data including cluster updates to the resource manager 402-2, based on the information about the clusters received during the cluster monitoring of step 456. This causes the cluster data stored or maintained by the resource manager 402-2 (e.g., in managed resource data 402-2r) to be updated, such that the most recent status of the servers of the cluster environment 407 can be tracked. In some embodiments in which a failure is detected at step 458, the cluster updates sent to the resource manager at step 460 include an indication that a failure has occurred, and/or details about the failure such as the type of failure (e.g., server, cluster), and the identity of the failed resource.

When the resource manager 402-2 receives a cluster update indicating that a failure has occurred, the configuration module 402-1 and the resource manager 402-2 communicate such that configuration data about the failed resource (e.g., cluster, server) is obtained by the resource manager 402-2. As described above, the configuration data 402-1d is stored by the configuration module 402-1, and includes information about the cluster and/or server, including, for instance, the type of hypervisor executed, VMs, connectivity to networks and devices such as shared storage, licensing details, and the like.

Based on the configuration data obtained at step 462, the resource manager 402-2 identifies an optimal recovery server from among the standby server pool 416, at step 464. It should be understood that, as described above, the servers in the standby server pool 416 are servers in other clusters of the cluster environment 407, rather than a set of servers separate from the clusters managed by the management system 402.

As described above, when adding servers to the standby server pool at step 454, the configuration of the servers being added is checked to ensure that the candidate recovery servers in the standby server pool 416 represent to some extent all of the clusters or servers in the cluster environment in which they would have to be added. Accordingly, identifying the optimal recovery server at step 464 includes finding a server in the standby server pool 416 that has a configuration most resembling the configuration of the failed resource (e.g., server, cluster). It should be understood that the criteria and weights used to determine the resemblance of two servers (e.g., in order to identify an optimal recovery server) can be set by each server, cluster, and/or management system. For example, in one instance, the hypervisor executing on the candidate recovery servers of the standby server pool 416 can be deemed as the most important factor, while in other instances, the connectivity of the candidate recovery servers can be the most important factor.

Still with reference to step 464, the optimal recovery server identified at step 464 can be based on the type of failure that is detected at step 458. For instance, if a server failure type is detected at step 458, the optimal recovery server in the standby server pool 416 can be the server with a configuration most resembling the failed server. If instead a cluster failure type is identified at step 458, the optimal recovery server can be a server with a configuration most resembling or compatible with the configuration of the failed cluster.

As described above, in some embodiments, the servers in the standby server pool 416 are in sleep power mode to provide power efficiency. The servers in the standby server pool 416 can be in sleep mode prior to being mapped to the standby server pool, or can be put into the sleep mode, if needed, when being added to the standby server pool 416. Thus, in turn, at step 466, the resource manager 402-2 wakes the optimal recovery server identified at step 464 from its sleep mode. In some embodiments, waking the optimal recovery server from the sleep mode is performed by transmitting a message from the resource manager 402-2 to the optimal recovery server. This message can be sent, for example, based on the Wake-on-LAN networking standard that allows a system to be turned on or awakened via a network message.

In turn, at step 468, the awakened optimal recovery server is configured. As described above, the configuration module 402-1 of the management system 402 stores configuration data about clusters (and servers of those clusters) that are part of the cluster environment 407, which are managed by the management system 402. For each cluster and/or server, the configuration module 402-1 can store different types of configuration information. While a variety of types of configuration information can be stored, in some embodiments, the configuration information of a server can include data indicating devices with which the server is connected (e.g., shared storage devices); networking profiles for communications with other devices; hypervisors, virtual machines, operating systems and applications executed by or running on the server, and licensing information therefor. In some embodiments, the configuration information for a cluster can include the same or different types of data the configuration information for a server. For instance, additionally or alternatively, cluster configuration information can include information indicating the servers of or associated with the cluster, and aggregate data about its servers (e.g., a list of the different devices with which its servers communicate).

In connection with the configuration of the recovery server, the resource manager 402-2 can obtain relevant configuration information from the configuration module 402-1. The relevant configuration information is in some embodiments the configuration data of the failed server and/or failed cluster. If the detected failure is a server failure, the configuration data of the failed server is used to configure the recovery server such that it matches or substantially matches the failed server. In some embodiments, configuring the recovery sever includes connecting the recovery server to the devices (e.g., shared storage device) with which the failed server was connected; applying network profiles of the failed server, including for example creating virtual networks and switches; adding and/or executing hypervisors, VMs, OSs and applications to the recovery server; and/or updating licensing information (e.g., software licenses) previously associated with the failed server such that the licenses of the failed server are changed to be associated with the recovery server (e.g., thereby enabling the licensed software for use on the recovery server rather than on the failed server).

In some embodiments, if the detected failure is a cluster failure, the recovery server is configured so as to match certain configurations of the cluster and/or its servers, and/or be compatible therewith. That is, in contrast to the case of a server failure, when a cluster failure is detected there is no failed server with which the recovery server has to be matched. Instead, the recovery server is configured so that it can operate in a similar manner as the other servers of the failed cluster. For instance, if the failed cluster and/or its servers are communicatively coupled to a shared storage device, the recovery server is likewise configured at step 468 to be communicatively coupled to that same storage device.

It should be understood that, in some embodiments, configuring the recovery server in step 468ca include activating, executing and/or running resources (e.g., hypervisor, VM, etc.) thereon.

Notably, as is readily apparent in light of the configuration step 468, when the optimal recovery server is identified from the standby server pool at step 464, the resource manager 402-2 intelligently determines the most suitable recovery server to minimize the amount and/or complexity that is performed during configuration at step 468. That is, if a candidate recovery server has all or many of the same connections and networking profiles, among other things, as the failed server, it would likely be deemed optimal because there would not be a need to add or remove connections and/or networking profiles to the recovery server at step 468.

In turn, at step 470, the clusters of the cluster environment 407 are updated, which can include adding a server to a cluster and/or replacing a server in a cluster with another server. Moreover, it should be understood that adding to or replacing a server in a cluster with a separate, recovery server does not require physical movement of the recovery server relative to the failed cluster or failed server. That is, in some embodiments, as used herein, adding a server to a cluster refers to associating a server with a new cluster and disassociating the server from its then corresponding cluster; and removing a server from a cluster refers to disassociating a server from its then corresponding cluster.

Accordingly, if the failure detected at step 458 is a server failure, updating the clusters at step 470 includes (in no particular order): (i) adding the recovery server to the cluster of the failed server; (ii) removing the recovery server from its then or prior corresponding cluster; and (iii) removing the failed server from its cluster. On the other hand, if the failure is a cluster failure, updating the clusters at step 470 includes (in no particular order): (i) adding the recovery server to the failed cluster; and (ii) removing the recovery server from its then or prior corresponding cluster. As described above, a cluster failure can refer to an instance in which conditions or thresholds of a cluster are not met and/or exceeded. For instance, if the percentage of servers in a clusters that are active (e.g., not idle and/or available for recovery) exceeds a certain threshold (e.g., 80%), the resource utilization of the cluster triggers a failure. In such cases, there is no need to remove a server from the cluster. Instead, there is a need to add servers to the clusters so that the thresholds or conditions (e.g., resource utilization) can be satisfied.

Although not illustrated in FIG. 5, in some embodiments, updating the clusters can include removing recovery servers from the standby server pool. That is, if a recovery server is added to a cluster, the recovery server can be removed from the standby server pool 416, if it is determined that it is no longer eligible to be a candidate recovery server. Removing the recovery server from the standby server pool can refer to the unmapping of the recovery server therefrom (e.g., by changing the state of its Standby Server Pool flag).

It should be understood that although the process of steps 450 to 470 is described with respect to a single server or cluster failure, in some embodiments, the process can perform multiple failure recoveries and/or re perform multiple server replacements or additions simultaneously or partially simultaneously. For instance, if a cluster failure is detected at step 458, the management system can identify multiple optimal recovery servers, wake those servers up, configure them, and add those multiple recovery servers to the failed cluster.

At step 472, the cluster monitor continues to monitor the clusters in the cluster environment 407. As described above, although this monitoring is illustrated in step 472, it should be understood that cluster monitoring can be performed continuously and or periodically throughout the process illustrated in FIG. 5.

Various embodiments described herein may be implemented at least in part in any conventional computer programming language. For example, some embodiments may be implemented in a procedural programming language (e.g., “C”), or in an object oriented programming language (e.g., “C++”). Other embodiments may be implemented as a pre-configured, stand-alone hardware element and/or as preprogrammed hardware elements (e.g., application specific integrated circuits, FPGAs, and digital signal processors), or other related components.

In an alternative embodiment, the disclosed systems and methods may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments may be implemented as a combination of both software (e.g., a computer program product) and hardware. Still other embodiments of the invention are implemented as entirely hardware, or entirely software.'

Aspects of the present system and method are described herein with reference to sequence diagrams and/or block diagrams of methods, apparatuses and computer program products according to examples of the principles described herein. Each sequence or block of the diagrams, and combinations of sequences and blocks in the diagrams, may be implemented by computer usable program code. The computer usable program code may be provided to a processor of a general purpose computer, special purpose computer, or other programmable data processing apparatus to produce a machine, such that the computer usable program code, when executed via, for example, a system processor (e.g., FIG. 1, processor 104) or other programmable data processing apparatus, implement the functions or acts specified in the sequences and/or blocks of the diagrams. In one example, the computer usable program code may be embodied within a computer readable storage medium; the computer readable storage medium being part of the computer program product. In one example, the computer readable storage medium is a non-transitory computer readable medium.

The preceding description has been presented to illustrate and describe examples of the principles described. This description is not intended to be exhaustive or to limit these principles to any precise form disclosed. Many modifications and variations are possible in light of the above teaching.

1. A management system for managing a server cluster environment, comprising:
one or more processors; and
at least one memory communicatively coupled to the one or more processors, the at least one memory storing instructions executable by the one or more processors, which when executed: (1) cause the one or more processors to operate as a configuration module, a resource manager and a cluster monitor; and (2) further cause the one or more processors to:
maintain, by the resource manager, a standby server pool, the standby server pool comprising one or more servers selected from clusters comprising a plurality of servers that form a server cluster environment;
store, by the configuration module, configuration information of the clusters and the plurality of servers;
monitor, by the cluster monitor, the clusters and/or the plurality of servers;
automatically detect, by the cluster monitor, a failing cluster or failing server among the clusters or the plurality of servers;
identify, by the resource manager, an optimal recovery server from among the one or more servers in the standby server pool;
add the optimal recovery server to the failing cluster or the cluster of the failing server; and
configure the optimal recovery server based on one or more of the configuration information of the failing server or its corresponding cluster,
wherein the optimal replacement server is determined based on the configuration information of the failing cluster or failing server.

2. The management system of claim 1, wherein at least one of the servers of one of the clusters includes a type of hypervisor different from a type of hypervisor of at least one of the servers of another of the server clusters.

3. The management system of claim 1, wherein the maintaining of the standby server pool includes identifying eligibility of the plurality of servers based on one or more characteristics of the one or more servers, the one or more characteristics including: (i) compute resource utilization; (ii) active virtual machines (VMs); (iii) length of power state; and (iv) network connectivity.

4. The management system of claim 3, wherein the maintaining of the one or more standby server pools includes continuously or periodically detecting eligible servers from among the plurality of servers and adding the eligible servers to the standby server pool.

5. The management system of claim 3, wherein:
the compute resource utilization indicates the utilization of resources including a central processing unit (CPUs), memory and disk;
a server with fewer active VMs than another server is given higher server eligibility,
a server in an off power state for longer than a threshold amount of time or in the off power state for longer than another server is given higher server eligibility,
a server having a network configuration matching or similar to a network configuration of the clusters or the plurality of servers is given a higher server eligibility.

6. The management system of claim 1, wherein the configuration information of the clusters and/or the plurality of servers includes one or more of connected systems information, network profiles, license data, and software executed thereon including one or more of a hypervisor, virtual machine, operation system, and applications.

7. The management system of claim 1,
wherein the instructions stored in the at least one memory, when executed, further cause the one or more processors to receive, by the cluster monitor, from the server cluster environment, state data indicating the state of each of the clusters and/or each of the plurality of servers,
wherein the identifying of the failing cluster or the failing server is based on the received state data.

8. The management system of claim 7,
wherein the failing cluster is identified based on the state data by determining that the failing cluster exceeded a respective utilization threshold, and
wherein the failing server is identified based on the state data by determining that the failing cluster did not transmit a heartbeat signal at an expected time.

9. The management system of claim 1, wherein the configuring of the optimal recovery server includes applying at least a portion of the configuration information of the failing server and/or failing cluster to the optimal replacement server.

10. The management system of claim 9, wherein the applying of the at least a portion of the configuration information includes one or more of: (i) applying a shared storage configuration similar to the failing server or failing cluster; (ii) creating virtual switches for communicating with other servers in the respective cluster; and (iii) applying licensing information to the optimal recovery server.

11. A system for managing server clusters, comprising:
a processor; and
a memory storing:
(1) server data and cluster data corresponding, respectively, to a plurality of clusters and a plurality of servers logically grouped into the plurality of clusters,
wherein servers in each of the plurality of clusters are at least partially configured according to a respective cluster configuration, such that servers in one of the clusters is configured according to a first cluster configuration and servers in another one of the clusters is configured according to a different, and
wherein each of the clusters is associated with a corresponding availability threshold; and
(2) instructions executable by the processor which, when executed, cause the processor to:
monitor the servers and the clusters, including identifying at least the state of each of the servers and/or the resource availability of each of the clusters;
identify, based on the monitoring, a server failure and/or a cluster failure among the servers and the clusters;
add an optimal recovery server to a cluster in which the server failure and/or the cluster failure were identified, the optimal recovery server being selected from a standby server pool made up of servers from the plurality of servers,
wherein, after adding the optimal recovery server, the resource availability of the cluster in which the server failure and/or the cluster failure were identified does not exceed the corresponding availability threshold.

12. A method for managing a server cluster environment, comprising:
identifying clusters to be monitored, each of the clusters comprising one or more servers and forming a server cluster environment including a plurality of servers;
maintaining a standby server pool comprising one or more servers selected from among the plurality of servers;
storing configuration information of the clusters and the plurality of servers;
monitoring the clusters and/or the plurality of servers;
automatically detecting a failing cluster or failing server among the clusters or the plurality of servers;
identifying an optimal recovery server from among the one or more servers in the standby server pool;
adding the optimal recovery server to the failing cluster or the cluster of the failing server; and
configuring the optimal recovery server based on one or more of the configuration information of the failing server or its corresponding cluster,
wherein the optimal server is determined based on the configuration information of the failing cluster or failing server.

13. The method of claim 12, wherein at least one of the servers of one of the clusters includes a type of hypervisor different from a type of hypervisor of at least one of the servers of another of the server clusters.

14. The method of claim 12, wherein maintaining the standby server pool includes identifying eligibility of the plurality of servers based on one or more characteristics of the one or more servers, the one or more characteristics including: (i) compute resource utilization; (ii) active virtual machines (VMs); (iii) length of power state; and (iv) network connectivity.

15. The method of claim 14, wherein maintaining the one or more standby server pools includes continuously or periodically detecting eligible servers from among the plurality of servers and adding the eligible servers to the standby server pool.

16. The method of claim 14, wherein:
the compute resource utilization indicates the utilization of resources including a central processing unit (CPUs), memory and disk;
a server with fewer active VMs than another server is given higher server eligibility,
a server in an off power state for longer than a threshold amount of time or in the off power state for longer than another server is given higher server eligibility,
a server having a network configuration matching or similar to a network configuration of the clusters or the plurality of servers is given a higher server eligibility.

17. The method of claim 12, wherein the configuration information of the clusters and/or the plurality of servers includes one or more of connected systems information, network profiles, license data, and software executed thereon including one or more of a hypervisor, virtual machine, operation system, and applications.

18. The method of claim 12,
wherein the instructions stored in the at least one memory, when executed, further cause the one or more processors to receive, by the cluster monitor, from the server cluster environment, state data indicating the state of each of the clusters and/or each of the plurality of servers,
wherein the identifying of the failing cluster or the failing server is based on the received state data,
wherein the failing cluster is identified based on the state data by determining that the failing cluster exceeded a respective utilization threshold, and
wherein the failing server is identified based on the state data by determining that the failing cluster did not transmit a heartbeat signal at an expected time.

19. The method of claim 12, wherein the configuring of the optimal recovery server includes applying at least a portion of the configuration information of the failing server and/or failing cluster to the optimal replacement server.

20. The method of claim 19, wherein the applying of the at least a portion of the configuration information includes one or more of: (i) applying a shared storage configuration similar to the failing server or failing cluster; (ii) creating virtual switches for communicating with other servers in the respective cluster; and (iii) applying licensing information to the optimal recovery server.
